(19) United States
(12) Patent Application Publication
(10) Pub. No.: US 2025/0130335 A1
(43) Pub. Date: Apr. 24, 2025

(54) Method and System for Using a PAA to Detect Spoofing Signals

(71) Applicant: Viavi Solutions, Inc., Chandler, AZ (US)

(72) Inventors: Leonid Kazakevich, Plainview, NY (US); Gregor Said Jackson, Las Vegas, NV (US)

(21) Appl. No.: 18/820,888

(22) Filed: Aug. 30, 2024

Related U.S. Application Data
(60) Provisional application No. 63/545,108, filed on Oct. 20, 2023.

(51) Int. Cl. G01S 19/21; G01S 19/36

(52) U.S. Cl. CPC G01S 19/215; G01S 19/36

(57) ABSTRACT

Disclosed is a method for detecting a spoofing source in satellite communications, the method comprising using a PAA to form beams corresponding to incoming signals originating from a plurality of signal sources. The PAA identifies positions of the plurality of signal sources. Next, almanac positions of known satellites in a constellation of satellites are compared with positions of the plurality of signal sources to match the plurality of signal sources with the known satellites. Thereafter, each unmatched signal source in the plurality of signal sources is designated as a spoofing source. In one implementation, a spoofing signal is used as a signal of opportunity by calculating and communicating corrected position and time information to users that receive the spoofing signal.

### CLAIM OF PRIORITY

The present application claims the benefit of and priority to a pending provisional patent application entitled “Phased Antenna Arrays Using LMS Filters,” Ser. No. 63/545,108 filed on Oct. 20, 2023. The disclosure in that pending provisional application is hereby incorporated fully by reference into the present application.

### BACKGROUND

Spoofing signals are pernicious and have deleterious effect in critical satellite communications, such as those involving GNSS and GPS satellite networks. Spoofing signals are often high-powered signals that overtake the lower power of satellite signals and mislead the signal recipient by providing incorrect time and position data.

Thus, there is a need in the art for effective detection of spoofing signals to maintain viability of navigation and other systems that rely on satellite communications. Moreover, there is a need to take advantage of the generally high-powered spoofing signals as signals of opportunity to provide accurate position and time data to users who otherwise rely on weaker signals from satellite networks.

### SUMMARY

The present disclosure is directed to method and system for using a Phased Antenna Array (PAA) to detect spoofing signals substantially as shown in and/or described in connection with at least one of the figures, and as set forth in the claims.

### BRIEF DESCRIPTION OF THE DRAWINGS

FIG. 1 shows one exemplary implementation of a Phased Antenna Array (PAA).

FIG. 2 shows another exemplary implementation of a PAA.

FIG. 3A shows a map of positions of incoming signal sources detected by a PAA according to one implement of the present application.

FIG. 3B shows a map of positions of actual satellites in a satellite constellation constructed by using an almanac according to one implement of the present application.

FIG. 4A shows the resulting of matching of the maps of FIGS. 3A and 3B according to one implement of the present application.

FIG. 4B is a table listing signal sources by their identifying codes and their unique azimuth (AZ) and elevation (EL).

FIG. 5 illustrates an implementation that utilizes a spoofing signal as a signal of opportunity to provided corrected position and time data to users.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

In one implementation of the present inventive concepts, a Phased Antenna Array (PAA) is utilized to receive satellite signals, such as GNSS (Global Navigation Satellite System) signals, and steer beams and nulls in a method for detecting a spoofing source in satellite communications. The PAA also known as a phased array antenna or simply phased array, is a type of antenna system that consists of multiple individual antenna elements arranged in a specific geometric pattern. These elements work together to achieve various signal processing objectives, such as steering the antenna's beam in a particular direction or forming multiple beams.

The ability of PAAs to electronically steer beams and adapt to changing conditions makes them versatile and valuable tools for improving signal reception and transmission. The main principles of a phased antenna array, as briefly described below, include phase shifting, amplitude control, beam forming, array geometry, adaptive beam forming, electronic scanning, and signal processing.

Phase Shifting: Each antenna element in the array can be electronically controlled to introduce a specific phase shift to the signal it receives or transmits. This phase shift determines the direction in which the antenna array's main beam is pointing. By adjusting the phase of each element, the array can steer the beam electronically without physically moving the antenna.

Amplitude Control: In addition to phase control, phased arrays can adjust the amplitude (signal strength) of individual elements to further shape the radiation pattern and optimize performance.

Beam Forming: By carefully controlling the phase and amplitude of each element in the array, the phased antenna array can shape its radiation pattern to concentrate the energy in a specific direction. This is known as beam forming and allows for directional signal reception or transmission, enhancing signal strength and coverage in the desired direction while minimizing signal leakage in unwanted directions.

Array Geometry: The spatial arrangement of the individual antenna elements within the array is critical to achieving specific beam forming objectives. Different array geometries, such as linear, planar, or conformal arrays, offer unique advantages for different applications.

Adaptive Beam Forming: Phased arrays can adapt their beam forming patterns in real-time based on the changing environment. This adaptive capability is useful for tracking moving targets, rejecting interference, and optimizing signal reception or transmission under dynamic conditions.

Electronic Scanning: Traditional antennas rely on mechanical movement to change their orientation and steer their beams. In contrast, phased arrays can electronically scan their beams quickly and precisely without any physical movement. This electronic scanning capability is advantageous in applications requiring rapid beam repositioning, such as tracking targets in radar systems or maintaining satellite communication links.

Signal Processing: Phased antenna arrays often require complex signal processing algorithms to calculate the appropriate phase and amplitude adjustments for each element based on the desired beam forming or interference mitigation goals. Digital signal processing (DSP) techniques are commonly used for this purpose.

The present inventive concepts can be implemented to more advantageously utilize phased antenna arrays in various fields, such as satellite systems, radar systems, communication systems, wireless networks, and defense technologies.

In one implementation, the present inventive concepts are utilized in techniques for detecting spoofing targeting devices receiving satellite signals using phased antenna arrays. Satellite signals for navigation and communications have low power at receive point due to long distances from LEO (low earth orbit) and MEO (medium earth orbit), which make these signals susceptible to spoofing.

According to one implementation of the present application, first the signals generated by the multiple antennas in the PAA are combined utilizing an analog (radio frequency), digital, or a hybrid combination.

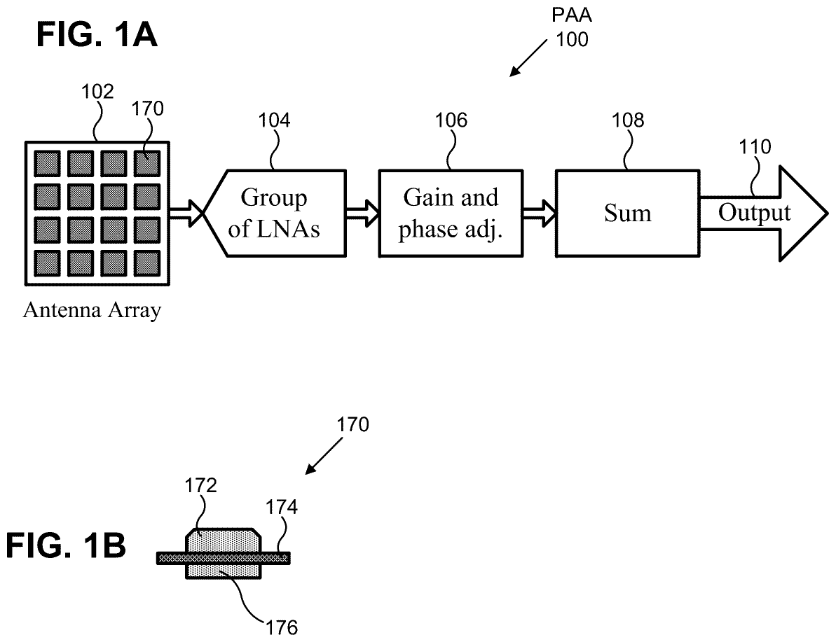

Referring to FIG. 1A, analog combining is done in RF or baseband. According to one implementation of the present application, PAA 100 comprises antenna array 102, group of low noise amplifiers (LNAs) 104, gain and phase adjustment module 106 and summing module 108. In the present example, antenna array 102 is an array of 16 antennas 170 arranged in four rows and four columns. However, any other number of antennas 170 with various number of rows or columns may be used according to the present disclosure. An exemplary implementation of antenna 170 is shown in FIG. 1B. Segment 172 of antenna 170 receives satellite signals while segment 176 receives primarily spoofing signals. PCB (printed circuit board) 174 is situated between segment 172 and segment 176 of antenna 170.

Satellite communication signals received by the multiple antennas in antenna array 102 are provided to LNAs 104 for amplification and the output of LNAs 104 is provided to gain and phase adjustment module 106, which can vary the gain and phase of each analog output corresponding to each antenna in antenna array 102. The gain and phase adjusted outputs of all antennas provided by antenna array 102 and LNAs 104 are combined in summing module 108 to generate PAA output 110. It is noted that in the exemplary implementation in FIG. 1A, PAA output 110 is produced by analog combining in RF (radio frequency) the outputs of all antennas provided by antenna array 102 and LNAs 104. PAA output 110 will be used in a spoofing detection method and system as will be discussed further below.

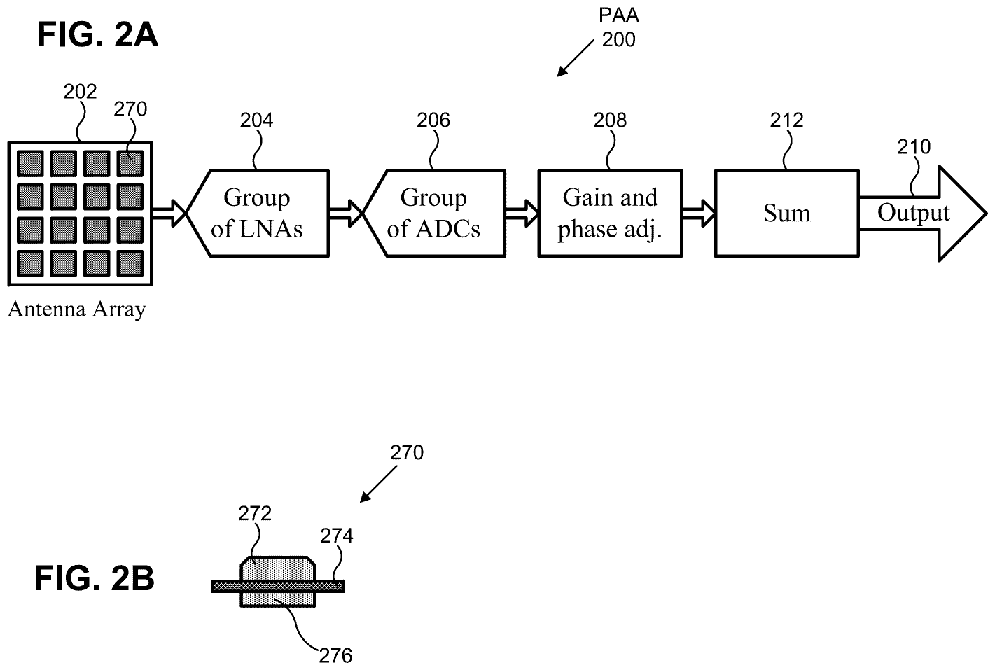

Referring to FIG. 2A, digital combining is done in digital domain after digitizing the antenna signals. According to another implementation of the present application, PAA 200 comprises antenna array 202, group of low noise amplifiers (LNAs) 204, group of ADCs (analog to digital converters) 206, gain and phase adjustment module 208, and summing module 212. In the present example, antenna array 202 is an array of 16 antennas 270 arranged in four rows and four columns. However, any other number of antennas 270 with various number of rows or columns may be used according to the present disclosure. An exemplary implementation of antenna 270 is shown in FIG. 2B. Segment 272 of antenna 270 receives satellite signals while segment 276 receives primarily spoofing signals. PCB 274 is situated between segment 272 and segment 276 of antenna 270.

In the present example, antenna array 202 is an array of 16 antennas arranged in four rows and four columns. However, any other number of antennas with various number of rows or columns may be used according to the present disclosure. Satellite communication signals received by the multiple antennas in antenna array 202 are provided to LNAs 204 for amplification and the output of LNAs 204 is provided to ADC module 206 which converts the analog outputs corresponding to each antenna in antenna array 202 to digital signals. The digital output of ADC module 206 is provided to gain and phase adjustment module 208, which can vary the gain and phase of each digital output corresponding to each antenna in antenna array 202. The gain and phase adjusted and digitized outputs of all antennas provided by antenna array 202 and LNAs 204 are combined in summing module 212 to generate PAA output 210. It is noted that in the exemplary implementation in FIG. 2A, PAA output 210 is produced in digital form by combining the digitized outputs of all antennas provided by antenna array 202 and LNAs 204. PAA output 210 will be used in a spoofing detection method and system as will be discussed further below.

Although PAA 100 is implemented in analog domain, while PAA 200 is implemented in digital domain, as known in the art a hybrid implementation is also possible wherein the output of the PAA is formed by a combination of analog and digital techniques.

One implementation of the present application is a method in which a PAA is used along with almanac data downloaded or stored in a system that includes the PAA to perform north finding and to detect a spoofing source in GNSS satellite communications. Almanac data includes a set of data about the orbits of all GNSS navigation satellites. Almanac data contains the GNSS network ephemerides, that is a tabular statement of the positions of the GNSS satellites at any given time. Almanac data according to the present implementation can be downloaded from one of the satellites in the GNSS constellation or any other network or may be already stored in the system that includes the PAA.

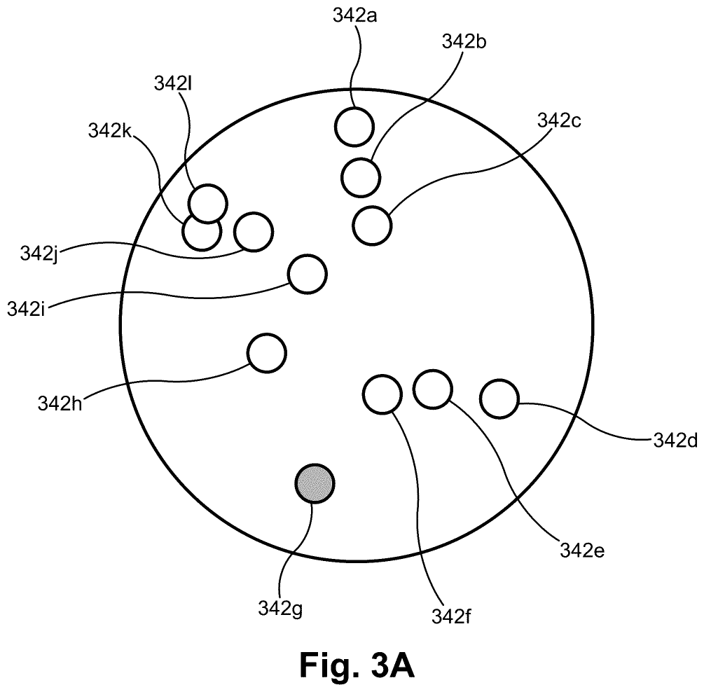

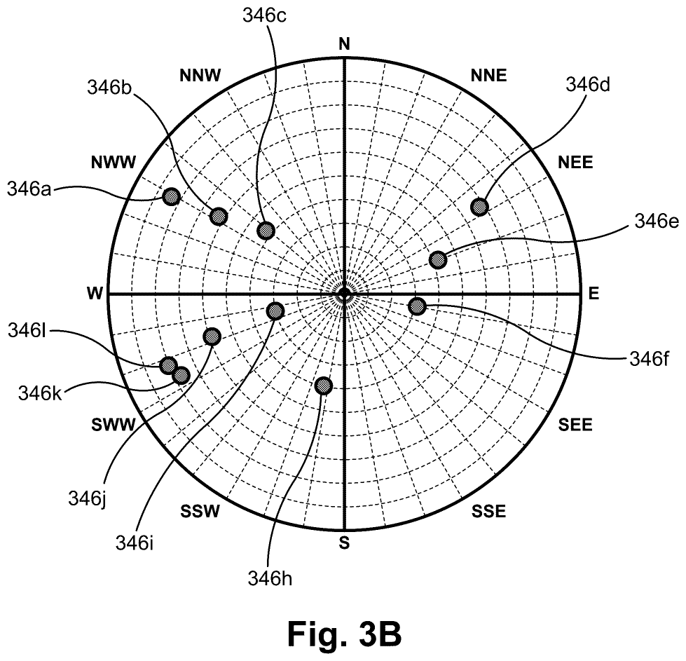

A phased antenna array, such as PAA 100 or PAA 200 discussed above, is utilized to form beams corresponding to incoming signals originating from a plurality of signal sources 342a, 342b, 342c, 342d, 342e, 342f, 342g, 342h, 342i, 342j, 342k, and 342l (collective referred to as signal sources 342a-342l) shown in FIG. 3A. Signal sources 342a-342l are intended to be originated from GNSS satellites and would generally correspond to positions of GNSS satellites. However, it is possible that a spoofing signal (also referred to as a spoofing source in the present application), is among the signal sources received by the PAA. For example, spoofing signal 342g is an example of a signal received by the PAA from a spoofing source.

Thus, with the aid of the PAA, a map of the satellite constellation based on each respective beam formed by the PAA is constructed. This map comprises signal sources 342a-342l as shown in FIG. 3A. Although the constructed satellite constellation map in FIG. 3A is shown as a two-dimensional map, it is usually a three-dimensional configuration.

Next, since the location of the PAA is known and the time of day is known, the pre-stored or downloaded almanac data would reveal the precise and actual formation of the satellite constellation in GNSS. Referring to FIG. 3B, the precise position of each satellite in the constellation is shown as actual satellite positions 346a, 346b, 346c, 346d, 346e, and 346f (collectively referred to as actual satellite positions 346a-346f) and 346h, 346i, 346j, 346k, and 346l (collectively referred to as actual satellite positions 346h-346l). Although the GNSS satellite constellation map in FIG. 3B is shown as a two-dimensional map, it is usually a three-dimensional configuration.

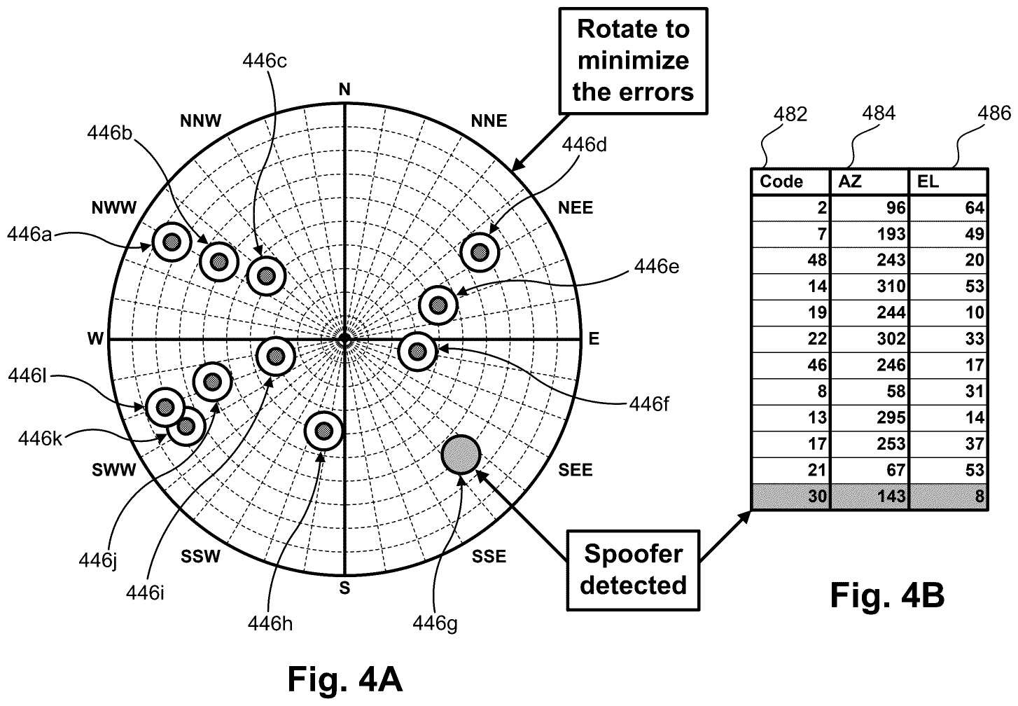

According to the present implementation, the PAA resides in a system that includes software that can rotate (on different axes) the three-dimensional map of the satellite constellation constructed in FIG. 3A to find identical matches in the three-dimensional map of the GNSS satellite constellation in FIG. 3B. The result of this rotation to find matches is shown in FIG. 4A. As seen in FIG. 4A, signal sources 342a, 342b, 342c, 342d, 342e, 342f (collectively referred to as signal sources 342a-342f) and signal sources 342h, 342i, 342j, 342k, and 342l (collectively referred to as signal sources 342h-342l) find exact positional matches in, respectively, actual satellite positions 346a-346f and 346h-346l. In FIG. 4A, these matched positions are indicated by satellite positions 446a, 446b, 446c, 446d, 446e, and 446f (collectively referred to as matched satellite positions 446a-446f) and satellite positions 446h, 446i, 446j, 446k, and 4461 (collectively referred to as matched satellite positions 446h-4461). As a result of matching the received signal sources 342a-342f and 342h-342l to actual satellite positions 346a-346f and 346h-346l, the position of “true north” relative to the PAA's position is also determined.

It is noted that “true north” is distinct from “magnetic north.” True north refers to the Earth's north pole, which is the intersection of 90° north latitude or the meridian. It is the direction that passes through a point on the Earth and points toward the Earth's geographical north pole. The tangent direction of the true meridian passing through a certain point on the Earth's surface becomes the true meridian direction of that point. Magnetic north is the north indicated by a compass, primarily because the poles of the Earth's magnetic field do not coincide with the geographic north and south poles. As such, the north indicated by a compass is magnetic north, not true north, and magnetic north changes over time.

As seen in FIGS. 3A/4A, signal source 342g/446g has not matched any of the satellite positions identified by the almanac. That is, signal source 342g/446g is received from azimuth and elevation angles that do not correspond to a known satellite. Therefore, signal source 342g/446g is designated as a spoofing signal source. FIG. 4B is a table listing each signal source by its identifying code in column 482 that corresponds to a unique azimuth (AZ) and elevation (EL), identified in columns 484 and 486, respectively. Since the position of true north has been precisely identified, the azimuth and elevation information in columns 484 and 486 are sufficient to uniquely identify the position of the spoofing signal source 342g/446g.

Moreover, if two or more codes are received from the same signal source, that would also indicate presence of a spoofer. In that case, the azimuth and elevation of the signal source providing two or more codes identify the position from which the spoofing signal has been originated.

In the examples of FIGS. 3A, 3B, 4A and 4B, there are eleven satellites in the constellation. However, in other implementations there may be greater or fewer number of satellites. In the present implementation, the software in the PAA system finds the true north by rotating positions of received signal sources. The amount of rotation is determined by minimizing an error, that is defined as a sum of distances between the positions of the received signal sources and the positions of satellites known from the almanac. Minimizing this error will determine the amount of required rotation to achieve the best matching between the positions of the received signal sources and the positions of actual satellites. As discussed above, this results in finding the true north and also identifying the spoofing signal source. Once a signal source is designated as the spoofing signal source, its corresponding code from the table in FIG. 4B is reported to the system as the spoofing signal code.

In one implementation, the spoofing signal can be used as “a signal of opportunity” to provide precise time and position data to mobile users, such as land vehicles or aerial vehicles, for example an unmanned aerial vehicle (UAV), or to stationary users. Spoofing signals are usually high-powered signals exceeding the power of signals received from actual communication satellites, such as GNSS satellites. Therefore, if an accurate correction to time and position information embedded in the spoofing signal is calculated, various mobile or stationary users can utilize the high-powered spoofing signal by making an accurate correction to its time and position information and thus use the spoofing signal as a high-powered and accurate navigation signal.

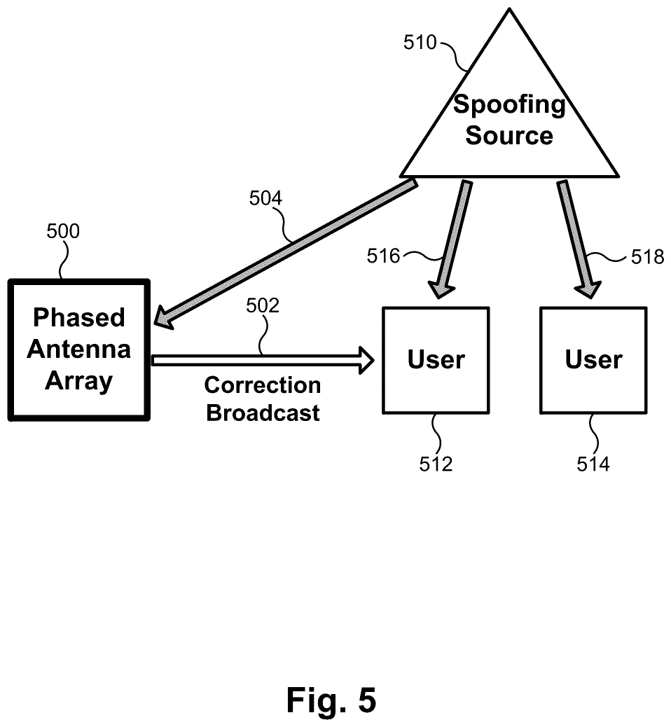

FIG. 5 illustrates this implementation. In FIG. 5 a phased antenna array, shown as PAA 500 is utilized. Either PAA 100 or PAA 200 discussed above or any other suitable PAA may be used as PAA 500. PAA 500 is equipped with software to detect a spoofing signal source in the manner described in relation to FIGS. 3A-3B and 4A-4B above. PAA 500 receives spoofing signal 504 from spoofing source 510 and designates the signal as a spoofing signal. Once spoofing signal 504 is detected, the difference between the time and position communicated by the spoofing signal and those communicated by GNSS satellites can be accurately calculated by software that is included in the system in which PAA 500 resides.

The difference between time and position is then transmitted by correction broadcast 502 to users 512 and 514. Users 512 and 514 may be mobile or stationary users as stated above. Users 512 and 514 concurrently receive high-powered spoofing signal 516 and 518 from spoofing source 510. Since correction broadcast 502 contains a precise correction to the time and position data transmitted by spoofing source 510, users 512 and 514 can make accurate corrections to the high-powered spoofing signals 516 and 518 and use the high-powered and corrected spoofing signal as “a signal of opportunity” for accurate navigation and other purposes.

In one implementation, the above-described technique can be used for Real Time Kinematic (RTK) correction to increase the accuracy of GNSS positions using the PAA in a fixed base station that wirelessly sends out correctional data to a moving receiver. In another implementation, the above-described technique can be utilized to perform precise guidance for an UAV (unmanned aerial vehicle) by placing the PAA in a known location, and utilizing it as a Wide Area Augmentation System (WAAS). In this implementation, extremely accurate navigation signals are provided by augmenting the Global Positioning System (GPS).

The present application has disclosed various exemplary implementations that result in detecting spoofing signals and also for the use of corrected spoofing signals. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

1. A method for detecting a spoofing source in satellite communications, said method comprising:
using a PAA to form beams corresponding to incoming signals originating from a plurality of signal sources;
said PAA identifying positions of said plurality of signal sources;
reading almanac positions of known satellites in a constellation of satellites;
comparing said identified positions of said plurality of signal sources with said almanac positions of known satellites to match said plurality of signal sources with said known satellites;
designating each unmatched signal source in said plurality of signal sources as said spoofing source.

2. The method of claim 1, wherein said PAA comprises an antenna array coupled to a group of LNAs, said group of LNAs providing an output to a gain and phase adjustment module, said gain and phase adjustment module being coupled to a summing module that provides said PAA's output.

3. The method of claim 1, wherein said PAA comprises an antenna array coupled to a group of LNAs, said group of LNAs providing an output to a group of ADCs coupled to a gain and phase adjustment module, said gain and phase adjustment module being coupled to a summing module that provides said PAA's output.

4. The method of claim 1, wherein comparing said identified positions of said plurality of signal sources with said almanac positions of known satellites is performed by rotating a three dimensional configuration of said plurality of signal sources to find north and to match a three dimensional configuration of said almanac positions of known satellites.

5. The method of claim 1, wherein said constellation of satellites is a GNSS constellation of satellites.

6. The method of claim 1, wherein said almanac positions are read from an almanac that is either downloaded from a network or stored in a system that includes said PAA.

7. A system for detecting a spoofing source in satellite communications, said system comprising:
a PAA to form beams corresponding to incoming signals originating from a plurality of signal sources, said PAA identifying positions of said plurality of signal sources;
an almanac for providing almanac positions of known satellites in a constellation of satellites;
wherein said system compares said identified positions of said plurality of signal sources with said almanac positions of known satellites to match said plurality of signal sources with said known satellites, and wherein said system designates each unmatched signal source in said plurality of signal sources as said spoofing source.

8. The system of claim 7, wherein said PAA comprises an antenna array coupled to a group of LNAs, said group of LNAs providing an output to a gain and phase adjustment module, said gain and phase adjustment module being coupled to a summing module that provides said PAA's output.

9. The system of claim 7, wherein said PAA comprises an antenna array coupled to a group of LNAs, said group of LNAs providing an output to a group of ADCs coupled to a gain and phase adjustment module, said gain and phase adjustment module being coupled to a summing module that provides said PAA's output.

10. The system of claim 7, wherein said system compares said identified positions of said plurality of signal sources with said almanac positions of known satellites is performed by rotating a three dimensional configuration of said plurality of signal sources to find north and to match a three dimensional configuration of said almanac positions of known satellites.

11. The system of claim 7, wherein said constellation of satellites is a GNSS constellation of satellites.

12. The system of claim 7, wherein said almanac is either downloaded from a network or stored in said system.

13. A method comprising:
using a PAA to form beams corresponding to incoming signals originating from a plurality of signal sources;
said PAA identifying positions of said plurality of signal sources;
reading almanac positions of known satellites in a constellation of satellites;
comparing said identified positions of said plurality of signal sources with said almanac positions of known satellites to match said plurality of signal sources with said known satellites;
designating each unmatched signal source in said plurality of signal sources as a spoofing signal;
calculating a correction to position and time information provided by said spoofing signal;
broadcasting said correction to users, so as to enable said users to use a corrected spoofing signal.

14. The method of claim 13, wherein said user comprises a mobile user and a stationary user.

15. The method of claim 14, wherein said mobile user is a UAV (unmanned aerial vehicle).

16. The method of claim 13, wherein said PAA comprises an antenna array coupled to a group of LNAs, said group of LNAs providing an output to a gain and phase adjustment module, said gain and phase adjustment module being coupled to a summing module that provides said PAA's output.

17. The method of claim 13, wherein said PAA comprises an antenna array coupled to a group of LNAs, said group of LNAs providing an output to a group of ADCs coupled to a gain and phase adjustment module, said gain and phase adjustment module being coupled to a summing module that provides said PAA's output.

18. The method of claim 13, wherein comparing said identified positions of said plurality of signal sources with said almanac positions of known satellites is performed by rotating a three dimensional configuration of said plurality of signal sources to find north and to match a three dimensional configuration of said almanac positions of known satellites.

19. The method of claim 13, wherein said constellation of satellites is a GNSS constellation of satellites.

20. The method of claim 13, wherein said almanac positions are read from an almanac that is either downloaded from a network or stored in a system that includes said PAA.
